(19) United States
(12) Patent Application Publication
(10) Pub. No.: US 2024/0134147 A1
(43) Pub. Date: Apr. 25, 2024

(54) OPTICAL ELEMENT DRIVING MECHANISM

(71) Applicant: TDK TAIWAN CORP., Taoyuan City (TW)

(72) Inventors: Po-Xiang ZHUANG, Taoyuan City (TW); Chen-Hung CHAO, Taoyuan City (TW); Wei-Jhe SHEN, Taoyuan City (TW); Shou-Jen LIU, Taoyuan City (TW); Kun-Shih LIN, Taoyuan City (TW); Yi-Ho CHEN, Taoyuan City (TW)

(21) Appl. No.: 18/491,088

(22) Filed: Oct. 19, 2023

Related U.S. Application Data
(60) Provisional application No. 63/418,088, filed on Oct. 21, 2022.

(51) Int. Cl. G02B 7/08; G02B 27/64

(52) U.S. Cl. CPC G02B 7/08; G02B 27/646

(57) ABSTRACT

An optical element driving mechanism is provided. The optical element driving mechanism includes a movable portion used for connecting an optical element, a fixed portion, and a driving assembly used for driving the movable portion to move relative to the fixed portion. The movable portion is movable relative to the fixed portion.

### CROSS REFERENCE TO RELATED APPLICATIONS

This Application claims priority of U.S. Provisional Application No. 63/418,088, filed on 2022 Oct. 21, the entirety of which is incorporated by reference herein.

### BACKGROUND OF THE INVENTION

### Field of the Invention

The present disclosure relates to an optical element driving mechanism.

### Description of the Related Art

As technology has developed, it has become more common to include image-capturing and video-recording functions into many types of modem electronic devices, such as smartphones and digital cameras. These electronic devices are used more and more often, and new models have been developed that are convenient, thin, and lightweight, offering more choice to consumers.

Electronic devices that have image-capturing or video-recording functions normally include an optical system to drive an optical element (such as a lens) to move along its optical axis, thereby achieving auto focus (AF) or optical image stabilization (OIS). Light may pass through the optical element and may form an image on an optical sensor. However, the trend in modem mobile devices is to have a smaller size and a higher durability. As a result, how to effectively reduce the size of the optical system and how to increase its durability has become an important issue.

### BRIEF SUMMARY OF THE INVENTION

An optical element driving mechanism is provided. The optical element driving mechanism includes a movable portion used for connecting an optical element, a fixed portion, and a driving assembly used for driving the movable portion to move relative to the fixed portion. The movable portion is movable relative to the fixed portion.

In some embodiments, the optical element driving mechanism further includes a first magnetic permeable element disposed on the fixed portion, a second magnetic permeable element disposed on the fixed portion, a third magnetic permeable element disposed on the fixed portion, a third magnetic element disposed on the movable portion, a fourth magnetic element disposed on the movable portion, and a guiding assembly disposed on the fixed portion, including a first guiding element disposed on the fixed portion and a second guiding element disposed on the fixed portion.

In some embodiments, the driving assembly includes a first magnetic element disposed on the movable portion, a second magnetic element disposed on the movable portion, a first driving coil disposed on the fixed portion and corresponding to the first magnetic element, and a second driving coil disposed on the fixed portion and corresponding to the second magnetic element.

In some embodiments, the first magnetic element corresponds to the first guiding element. The second magnetic element corresponds to the second guiding element. The first magnetic element corresponds to the first magnetic permeable element. The third magnetic element corresponds to the second magnetic permeable element. The fourth magnetic element corresponds to the third magnetic permeable element.

In some embodiments, the first magnetic element and the first guiding element generates a first force to the movable portion. The second magnetic element and the second guiding element generates a second force to the movable portion. The first magnetic element and the first magnetic permeable element generates a third force to the movable portion. The third magnetic element and the second magnetic permeable element generates a fourth force to the movable portion. The fourth magnetic element and the third magnetic permeable element generates a fifth force to the movable portion.

In some embodiments, the first force, the second force, the third force, the fourth force, and the fifth force generates a resultant force to the movable portion. The resultant force is greater than zero in a first direction. The resultant force is greater than zero in a second direction. The first direction and the second direction are perpendicular. A direction of the first force is not parallel and not perpendicular to the first direction. The direction of the first force is not parallel and not perpendicular to the second direction. A direction of the second force is not parallel and not perpendicular to the first direction. The direction of the second force is not parallel and not perpendicular to the second direction.

In some embodiments, a direction of the third force is parallel to the first direction. A direction of the fourth force is parallel to the second direction. A direction of the fifth force is parallel to the first direction.

In some embodiments, a first distance is between the first magnetic permeable element and the first magnetic element in the first direction. A second distance is between the second magnetic permeable element and the third magnetic element in the second direction. A third distance is between the third magnetic element and the fourth magnetic element in the first direction. The first distance and the second distance are different. The first distance and the third distance are different. The second distance and the third distance are different.

In some embodiments, the first magnetic element has a first length in the second direction. The second magnetic element has a second length in the first direction. The third magnetic element has a third length in the first direction. The fourth magnetic element has a fourth length in the second direction. The first length and the third length are different. The first length and the fourth length are different. The second length and the third length are different. The second length and the fourth length are different.

In some embodiments, the first distance is greater than the third distance. The first length is greater than the third length. The first length is greater than the fourth length. The second length is greater than the third length. The second length is greater than the fourth length.

In some embodiments, the fixed portion includes a bottom. The first magnetic permeable element is disposed on the bottom. The second magnetic permeable element is disposed on the bottom. The third magnetic permeable element is disposed on the bottom. The bottom includes a bottom portion positioned between the second magnetic permeable element and the third magnetic permeable element. The bottom is not disposed between the third magnetic permeable element and the fourth magnetic element.

In some embodiments, the fixed portion includes a first side, a second side, a third side, and a fourth side. The first side is adjacent to the second side. The first side is adjacent to the third side. The second side is adjacent to the fourth side. The third side is adjacent to the fourth side. The first driving coil is disposed on the first side. The second driving coil is disposed on the second side. No driving coil is disposed on the third side and the fourth side.

In some embodiments, the bottom includes a first recess and a second recess. The first guiding element is disposed in the first recess. The second guiding element is disposed in the second recess. The first recess includes a first contact surface and a second contact surface. The second recess includes a third contact surface. The first guiding element is in direct contact with the first contact surface and the second contact surface. The second guiding element is in direct contact with the third contact surface.

In some embodiments, the second recess further includes a first limiting surface and a second limiting surface. The third contact surface is adjacent to the first limiting surface and the second limiting surface. The third contact surface is between the first limiting surface and the second limiting surface. The second guiding element is not in contact with the first limiting surface and the second limiting surface.

In some embodiments, the movable portion includes an opening. A main axis passes through a center of the opening. The main axis extends in a direction perpendicular to the first direction and the second direction. A first line passes through the first guiding element and the second guiding element when viewed along the main axis. A second line passes through the center and is perpendicular to the first line when viewed along the main axis. A third line extends in the first direction and passes through a center of the first magnetic element when viewed along the main axis. A fourth line extends in the second direction and passes through a center of the third magnetic element when viewed along the main axis. A fifth line extends in the first direction and passes through a center of the fourth magnetic element when viewed along the main axis. A direction of the resultant force is a third direction. The third direction is not perpendicular to a direction that the first line extends. The third direction is not parallel to a direction that the second line extends. The first line does not pass through the center. The third line and the fifth line do not overlap each other. The third line does not pass through the center. The fourth line does not pass through the center. The fifth line does not pass through the center. The center and the fifth line are positioned on opposite sides of the third line. Normal force between the first guiding element and the first contact surface is different than normal force between the first guiding element and the second contact surface.

In some embodiments, an angle between the third direction and the first direction is less than an angle between the third direction and the second direction. The first guiding element and the third magnetic element are disposed on an identical side of the second line. The second guiding element and the fourth magnetic element are disposed on an identical side of the second line. The normal force between the first guiding element and the first contact surface is greater than the normal force between the first guiding element and the second contact surface.

In some embodiments, the driving assembly further includes a position sensing element. The position sensing element and the first guiding element are disposed on an identical side of the second line when viewed along the main axis. The optical element driving mechanism further includes a circuit element and a temperature sensing element. The position sensing element and the temperature sensing element are disposed on the circuit element. The temperature sensing element is disposed on a corner of the optical element driving mechanism.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a schematic view of an optical element driving mechanism.

FIG. 2 is an exploded view of the optical element driving mechanism.

FIG. 3 is a top view of the optical element driving mechanism.

FIG. 4 is a cross-sectional view illustrated along the line A-A in FIG. 3.

FIG. 5, FIG. 6, FIG. 7, and FIG. 8 are top views of some elements of the optical element driving mechanism.

### DETAILED DESCRIPTION OF THE INVENTION

The following disclosure provides many different embodiments, or examples, for implementing different features of the provided subject matter. Specific examples of elements and arrangements are described below to simplify the present disclosure. These are, of course, merely examples and are not intended to be limiting. For example, in some embodiments, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

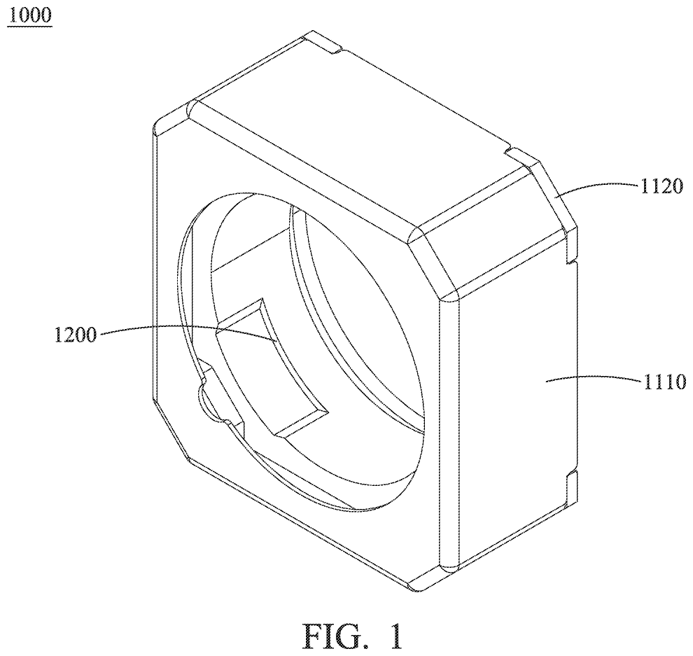

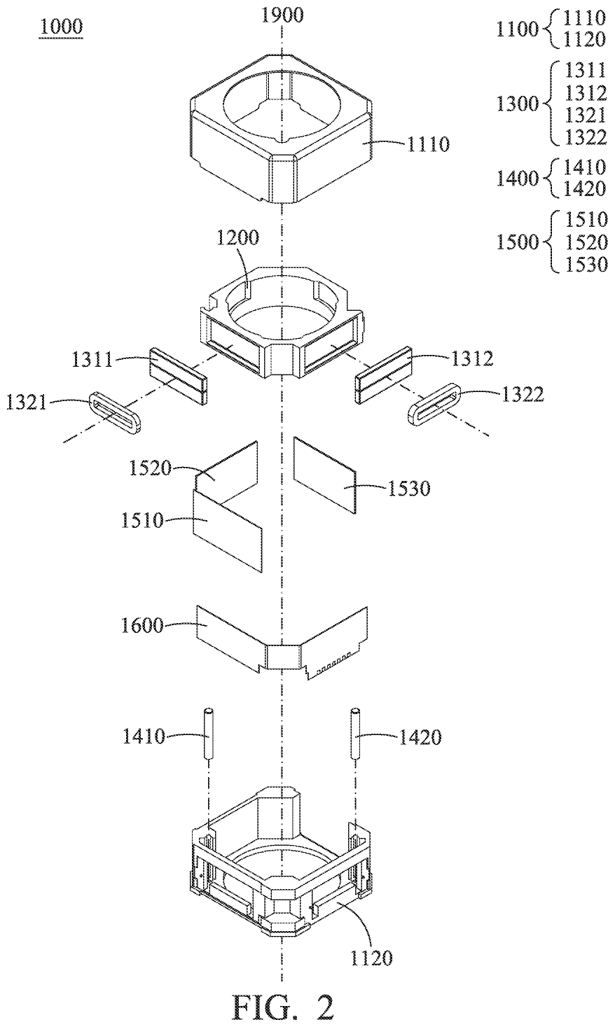

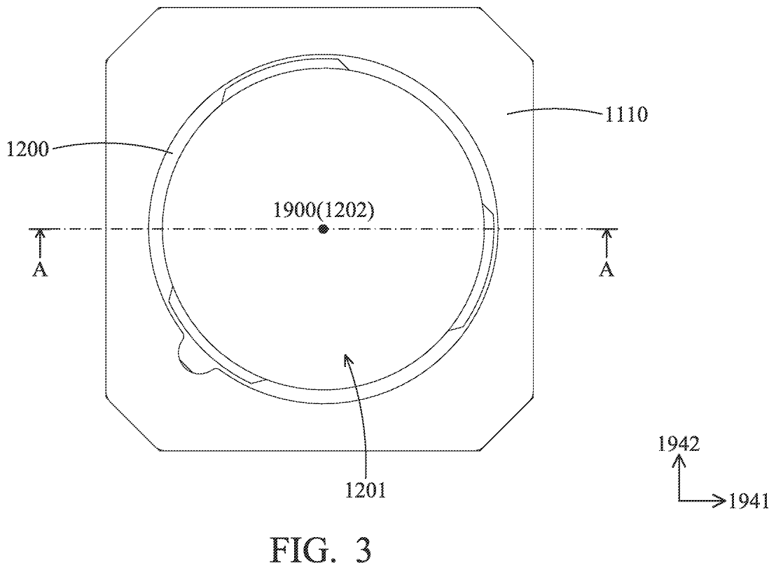

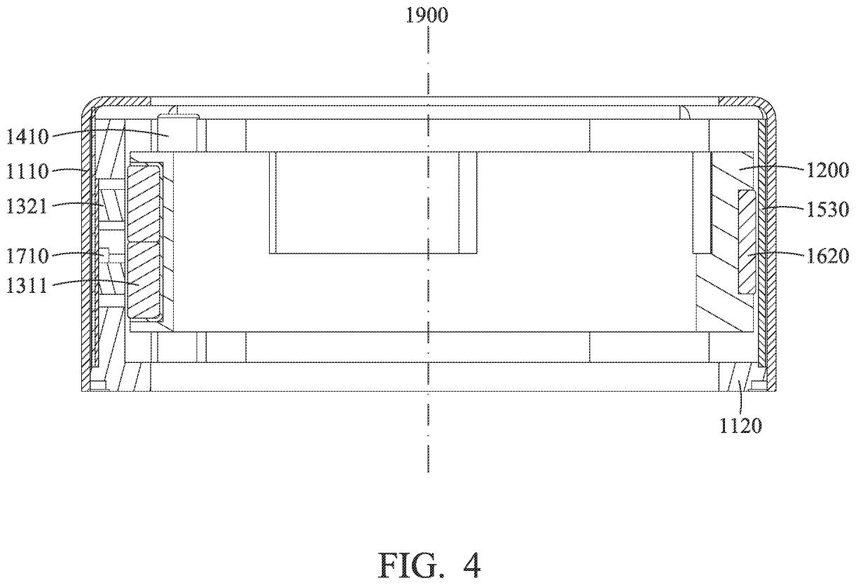

Embodiments of the present disclosure provide an optical element driving mechanism for driving a movable portion moving relative to the fixed portion. For example, FIG. 1 is a schematic view of an optical element driving mechanism 1000. FIG. 2 is an exploded view of the optical element driving mechanism 1000. FIG. 3 is a top view of the optical element driving mechanism 1000. FIG. 4 is a cross-sectional view illustrated along the line A-A in FIG. 3. As shown in FIG. 1 to FIG. 4, the optical element driving mechanism 1000 may include a fixed portion 1100, a movable portion 1200, a driving assembly 1300, a guiding assembly 1400, a magnetic permeable assembly 1500, and a circuit element 1600 arranged along a main axis 1900.

In some embodiments, the fixed portion 1100 may include a case 1110 and a bottom 1120, which may combine with each other to form a shell of the optical element driving mechanism 1000, and elements disposed inside may be protected. The movable portion 1200 may move relative to the fixed portion 1100, and an optical element (not shown) may be disposed in the movable portion 1200 to allow the optical element being driven by the optical element driving mechanism 1000 to move with the movable portion 1200, so auto focus (AF) may be achieved.

In some embodiments, the optical element may be, for example, a lens, a mirror, a prism, a reflective polished surface, an optical coating, a beam splitter, an aperture, a liquid lens, an image sensor, a camera module, or a ranging module. It should be noted that the definition of the optical element is not limited to the element that is related to visible light, and other elements that relate to invisible light (e.g. infrared or ultraviolet) are also included in the present disclosure.

In some embodiments, the driving assembly 1300 may include a first magnetic element 1311, a second magnetic element 1312, a first magnetic element 1321, and a second driving coil 1322 used for driving the movable portion 1200 to move relative to the fixed portion 1100. In some embodiments, the first magnetic element 1311 and the second magnetic element 1312 may include magnets. For example, the first magnetic element 1311 and the second magnetic element 1312 may be disposed on the movable portion 1200, and the first magnetic element 1321 and the second driving coil 1322 may be disposed on the fixed portion 1100. The first magnetic element 1311 and the second magnetic element 1312 may respectively generate electromagnetic forces with the first magnetic element 1321 and the second driving coil 1322 to drive the movable portion 1200 moving relative to the fixed portion 1100.

In some embodiments, positions of the first magnetic element 1311 and the second magnetic element 1312 may be interchanged with positions of the first magnetic element 1321 and the second driving coil 1322, such as the first magnetic element 1311 and the second magnetic element 1312 may be disposed on the fixed portion 1100, and the first magnetic element 1321 and the second driving coil 1322 may be disposed on the movable portion 1200, depending on design requirement.

In some embodiments, the guiding assembly 1400 may include a first guiding element 1410 and a second guiding element 1420 with columnar shapes, and they may extend in a direction that the main axis 1900 extending in. The first guiding element 1410 and the second guiding element 1420 may be affixed on the fixed portion 1100 (such as the bottom 1120), and the movable portion 1200 may be in contact with the first guiding element 1410 and the second guiding element 1420 by friction contact. Therefore, the movement direction of the movable portion 1200 relative to the fixed portion 1100 may be defined by the first guiding element 1410 and the second guiding element 1420.

For example, when the movable portion 1200 is driven by the driving assembly 1300, the electromagnetic force provided by the driving assembly 1300 may be greater than the maximum static friction between the movable portion 1200 and the guiding assembly 1400 to allow the movable portion 1200 moving relative to the fixed portion 1100. When power is not provided to the driving assembly 1300, the friction force between the movable portion 1200 and the guiding assembly 1400 may affix the movable portion 1200 on a specific position, so it is not required to keep providing power to the driving assembly 1300 to affix the movable portion 1200.

In some embodiments, the magnetic permeable assembly 1500 may include a first magnetic permeable element 1510, a second magnetic permeable element 1520, and a third magnetic permeable element 1530 disposed on the fixed portion 1100 (such as the bottom 1120) to define the magnetic field direction in the optical element driving mechanism 1000. The first magnetic permeable element 1510, the second magnetic permeable element 1520, and the third magnetic permeable element 1530 may include, for example, magnetic permeable metal.

In some embodiments, the circuit element 1600 may be flexible printed circuit (FPC) which may adhere on the bottom 1120. In this embodiment, the circuit element 1600 is electrically connected to electronic elements inside or outside the optical element driving mechanism 1000. For example, the circuit element 1600 may transmit electric signal to the driving assembly 1300 to control the movement of the movable portion 1200, so auto focus may be achieved.

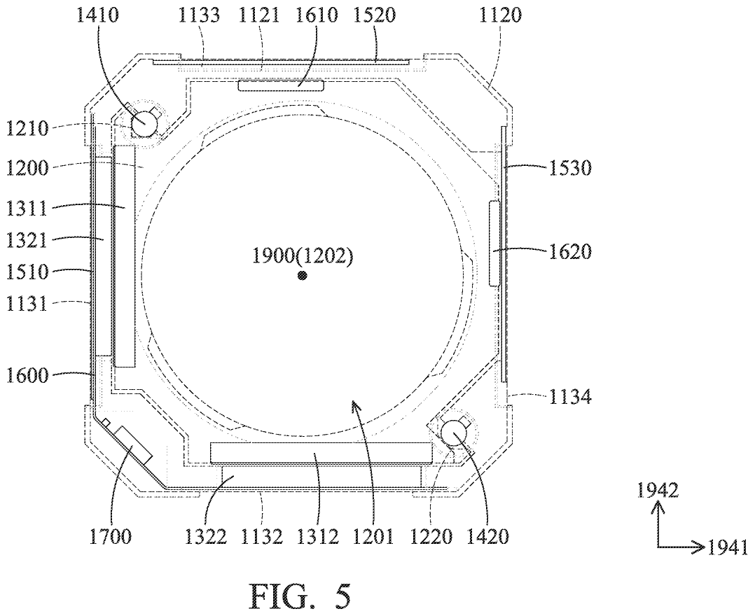

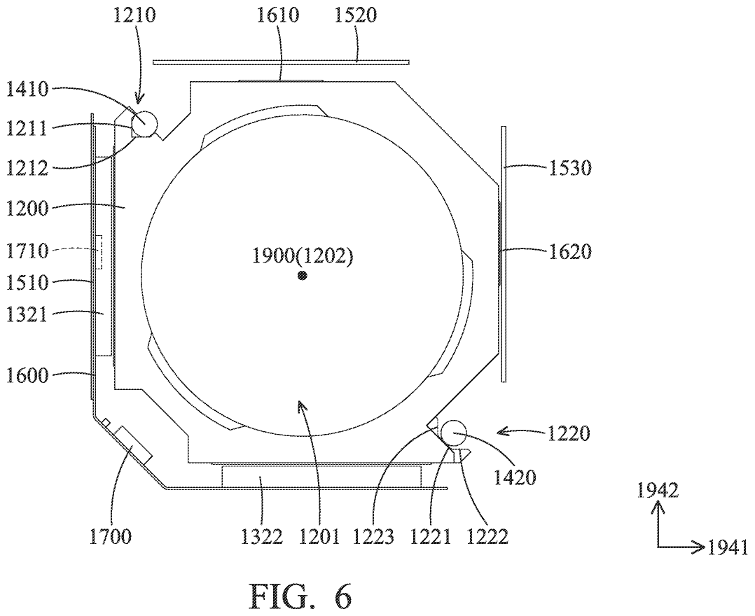

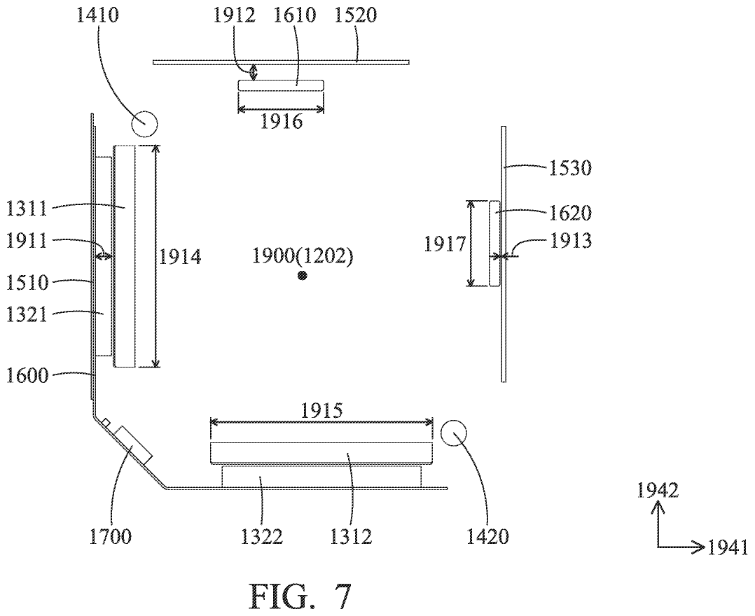

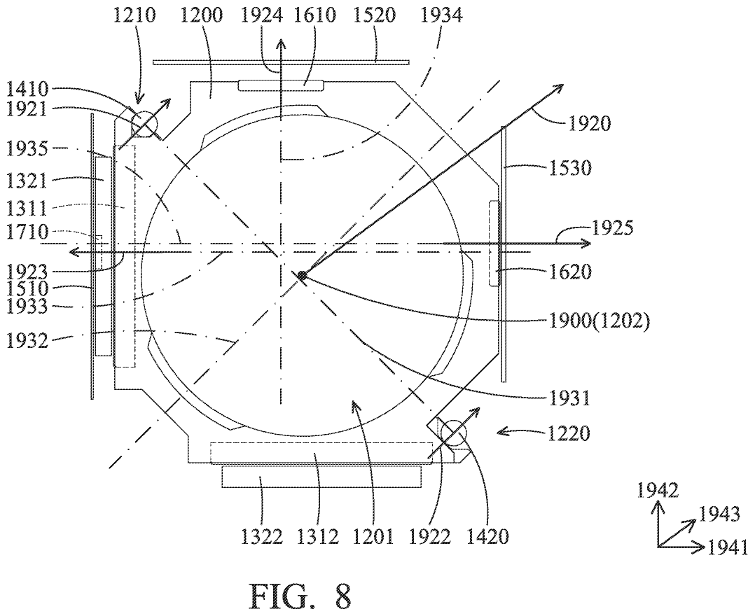

FIG. 5, FIG. 6, FIG. 7, and FIG. 8 are top views of some elements of the optical element driving mechanism 1000, and some elements are omitted to show details of other elements. As shown in FIG. 5 to FIG. 8, the optical element driving mechanism 1000 may further include a third magnetic element 1610, a fourth magnetic element 1620, a temperature sensing element 1700, and a position sensing element 1710. The third magnetic element 1610 and the fourth magnetic element 1620 may be magnets and disposed on the movable portion 1200, and the temperature sensing element 1700 and the position sensing element 1710 may be disposed on the circuit element 1600.

In some embodiments, as shown in FIG. 6, the movable portion 1200 may include a first recess 1210 and a second recess 1220, and the first guiding element 1410 and the second guiding element 1420 may be disposed in the first recess 1210 and the second recess 1220, respectively. In some embodiments, the first recess 1210 and the second recess 1220 may have different structures. In some embodiments, the first recess 1210 may have a first contact surface 1211 and a second contact surface 1212, the second recess 1220 may have a third contact surface 1221, a first limiting surface 1222, and a second limiting surface 1223, and the third contact surface 1221 may be between the first limiting surface 1222 and the second limiting surface 1223 and adjacent to the first limiting surface 1222 and the second limiting surface 1223.

In normal situation, the first contact surface 1211 and the second contact surface 1212 may be in contact with the first guiding element 1410, and the third contact surface 1221 may be in contact with the second guiding element 1420. The first limiting surface 1222 and the second limiting surface 1223 are not in contact with the second guiding element 1420. Therefore, when tolerance occurs during the manufacturing of the optical element driving mechanism 1000, the first guiding element 1410 and the second guiding element 1420 may be still disposed in the first recess 1210 and the second recess 1220, respectively.

However, since the contact area between the first guiding element 1410 and the movable portion 1200 may be greater than the contact area between the second guiding element 1420 and the movable portion 1200 (the first guiding element 1410 contacts both of the first contact surface 1211 and the second contact surface 1212, but the second guiding element 1420 only contacts the third contact surface 1221), if the normal force between the first guiding element 1410 and the second guiding element 1420 equals to the normal force between the first guiding element 1410 and the movable portion 1200, the friction between the first guiding element 1410 and the movable portion 1200 may be greater than the friction between the second guiding element 1420 and the movable portion 1200. Therefore, the movable portion 1200 may receive uneven force when moving along the main axis 1900, the movable portion 1200 may tilt rather than move along the main axis 1900. Therefore, the normal force between the first guiding element 1410 and the movable portion 1200 needs to be designed as less than the normal force between the second guiding element 1420 and the movable portion 1200, so the movable portion 1200 may receive uniform friction at the first guiding element 1410 and the second guiding element 1420 when the movable portion 1200 moves relative to the main axis 1900.

As shown in FIG. 7 and FIG. 8, the first magnetic element 1311 may correspond to the first guiding element 1410 and the first magnetic permeable element 1510, the second magnetic element 1312 may correspond to the second guiding element 1420, the third magnetic element 1610 may correspond to the second magnetic permeable element 1520, and the fourth magnetic element 1620 may correspond to the third magnetic permeable element 1530. The “correspond” means magnetic force is generated between two elements. As a result, a first force 1921 may be generated between the first magnetic element 1311 and the first guiding element 1410, a second force 1922 may be generated between the second magnetic element 1312 and the second guiding element 1420, a third force 1923 may be generated between the first magnetic element 1321 and the first magnetic permeable element 1510, a fourth force 1924 may be generated between the third magnetic element 1610 and the second magnetic permeable element 1520, and a fifth force 1925 may be generated between the fourth magnetic element 1620 and the third magnetic permeable element 1530.

In some embodiments, the first magnetic element 1311, the second magnetic element 1312, the third magnetic element 1610, and the fourth magnetic element 1620 are disposed on the movable portion 1200, so the first force 1921, the second force 1922, the third force 1923, the fourth force 1924, and the fifth force 1925 are forces applied on the movable portion 1200.

In some embodiments, the first force 1921 and the second force 1922 have positive components of vectors in the first direction 1941 and the second direction 1942, wherein the first direction 1941 and the second direction 1942 are perpendicular, and the first direction 1941 and the second direction 1942 are perpendicular to the direction that the main axis 1900 extends. In other words, the directions of the first force 1921 and the second force 1922 are not perpendicular or parallel to the first direction 1941 and the second direction 1942, such as in a direction substantially parallel to the second line 1932. In some embodiments, the third force 1923 and the first direction 1941 have opposite directions, directions of the fourth force 1924 and the second direction 1942 are identical, and directions of the fifth force 1925 and the first direction 1941 are identical.

In some embodiments, the first line 1931 may be defined as a line passes through the first guiding element 1410 and the second guiding element 1420 when viewed along the main axis 1900, and the second line 1932 may be defined as a line perpendicular to the first line 1931 and passes through a center 1202 of a opening 1201 of the movable portion 1200. It should be noted that the first line 1931 does not pass through the center 1202. Moreover, the main axis 1900 passes through the center 1202. In some embodiments, the center 1202 may be a center of mass of the movable portion 1200. In some embodiments, the center 1202 may be a middle point of the first guiding element 1410 and the second guiding element 1420. In some embodiments, the first guiding element 1410 and the third magnetic element 1610 may be disposed on an identical side of the second line 1932, and the second guiding element 1420 and the fourth magnetic element 1620 may be disposed on another side of the second line 1932.

In some embodiments, a third line 1933 may be defined as a line extends in the first direction 1941 and passes through the center of the first magnetic element 1311. A fourth line 1934 may be defined as a line extends in the second direction 1942 and passes through the center of the third magnetic element 1610. A fifth line 1935 may be defined as a line extends in the first direction 1941 and passes through the center of the fourth magnetic element 1620. In some embodiments, the third line 1933 and the fifth line 1935 may be parallel and do not overlap each other. In some embodiments, the third line 1933, the fourth line 1934, and the fifth line 1935 do not pass through the center 1202. When viewed along the main axis 1900, the center 1202 and the fifth line 1935 is at opposite sides of the third line 1933.

As mentioned above, in order to making the second guiding element 1420 receiving a greater normal force than the first guiding element 1410, it is desired that a resultant force 1920 formed by the first force 1921, the second force 1922, the third force 1923, the fourth force 1924, and the fifth force 1925 is more biased toward the second guiding element 1420. The direction of the resultant force 1920 may be defined as a third direction 1943, which is not parallel or perpendicular to the extending directions of the first line 1931 and the second line 1932. In other words, an angle between the direction of the resultant force 1920 (i.e. the third direction 1943) and the second line 1932 is greater than 0, and an angle between the third direction 1943 and the first direction 1941 is less than an angle between the third direction 1943 and the second direction 1942. Therefore, the second guiding element 1420 may receive a normal force greater than the normal force that the first guiding element 1410 received, so when the movable portion 1200 moves relative to the first guiding element 1410 and the second guiding element 1420, the total friction force received at the first guiding element 1410 and the second guiding element 1420 is consistent, thereby preventing the movable portion 1200 from overturning when it moves.

It should be noted that since the direction of the resultant force 1920 (i.e. the third direction 1943) is not parallel or perpendicular to the second line 1932, the normal vector of the first contact surface 1211 is parallel to the first direction 1941, and the normal vector of the second contact surface 1212 is parallel to the second direction 1942, so the normal forces received by the first contact surface 1211 and the second contact surface 1212 are different. For example, the normal force between the first guiding element 1410 and the first contact surface 1211 is greater than the normal force between the first guiding element 1410 and the second contact surface 1212.

In some embodiments, in order to make the direction of the resultant force 1920 meet the aforementioned description, the directions of the first force 1921 and the second force 1922 may be designed to be substantially parallel to the second line 1932, the magnitude of the fifth force 1925 is greater than the magnitude of the third force 1923, and the magnitude of the fourth force 1924 is less than the resultant force formed by the third force 1923 and the fifth force 1925 in the first direction 1941. Therefore, the resultant force 1920 is biased to the second guiding element 1420 to achieve aforementioned purpose.

For example, a first distance 1911 is between the first magnetic element 1311 and the first magnetic permeable element 1510 in the first direction 1941. A second distance 1912 is between the third magnetic element 1610 and the second magnetic permeable element 1520 in the second direction 1942. A third distance 1913 is between the fourth magnetic element 1620 and the third magnetic permeable element 1530 in the first direction 1941, the first distance 1911 is less than the third distance 1913, and the second distance 1912 is less than the third distance 1913. Therefore, the fifth force 1925 between the fourth magnetic element 1620 and the third magnetic permeable element 1530 may be increased to achieve the aforementioned purpose.

In some embodiments, the first magnetic element 1321 is disposed between the first magnetic element 1311 and the first magnetic permeable element 1510, a bottom portion 1121 of the bottom 1120 is disposed between the third magnetic element 1610 and the second magnetic permeable element 1520, and the bottom 1120 is not between the fourth magnetic element 1620 and the third magnetic permeable element 1530. Therefore, the distance between the first magnetic element 1311 and the first magnetic permeable element 1510 and the distance between the third magnetic element 1610 and the second magnetic permeable element 1520 may be increased to prevent the third force 1923 and the fourth force 1924 being too high.

In some embodiments, the first magnetic element 1311 and the second magnetic element 1312 need to interact with the first magnetic element 1321 and the second driving coil 1322 to drive the movable portion 1200, and the third magnetic element 1610 and the fourth magnetic element 1620 do not need to interact with any coil, so the sizes of the first magnetic element 1311 and the second magnetic element 1312 may be greater than the sizes of the third magnetic element 1610 and the fourth magnetic element 1620. For example, the first magnetic element 1311 has a first length 1914 in the second direction 1942, the second magnetic element 1312 has a second length 1915 in the first direction 1941, the third magnetic element 1610 has a third length 1916 in the first direction 1941, the fourth magnetic element 1620 has a fourth length 1917 in the second direction 1942, and the first length 1914 and the second length 1915 may be greater than the third length 1916 and the fourth length 1917.

In some embodiments, as shown in FIG. 5, the bottom 1120 may have a first side 1131, a second side 1132, a third side 1133, and a fourth side 1134, wherein the first side 1131 is adjacent to the second side 1132 and the third side 1133, and the fourth side 1134 is adjacent to the second side 1132 and the third side 1133. The first side 1131, the second side 1132, the third side 1133, and the fourth side 1134 may respectively correspond to the first magnetic element 1311, the second magnetic element 1312, the third magnetic element 1610, and the fourth magnetic element 1620. In some embodiments, the first magnetic element 1321 may be disposed on the first side 1131, the second driving coil 1322 may be disposed on the second side 1132, and no driving coil is disposed on the third side 1133 and the fourth side 1134.

In some embodiments, the temperature sensing element 1700 may be disposed on a corner of the optical element driving mechanism 1000 to detect the temperature of the optical element driving mechanism 1000. The position sensing element 1710 may be disposed on the first side 1131, and the position sensing element 1710 and the first guiding element 1410 may be disposed on an identical side of the second line 1932 when viewed along the main axis 1900. Since the movable portion 1200 receives a greater friction at the position that the position sensing element 1710 is disposed on and is therefore more stable, a more accurate measurement can be obtained when the position sensing element 1710 is used to measure the magnetic field of the first magnetic element 1311.

In some embodiments, the position sensing element 1710 may include a Hall sensor, a magnetoresistance effect sensor (MR sensor), a giant magnetoresistance effect sensor (GMR sensor), a tunneling magnetoresistance effect sensor (TMR sensor), or a fluxgate sensor.

In some embodiments, the third magnetic element 1610, the fourth magnetic element 1620, the second magnetic permeable element 1520, and the third magnetic permeable element 1530 may be replaced by other elements to provide the fourth force 1924 and the fifth force 1925 to the movable portion 1200, such as may be replaced by springs, piezoelectric elements, or shape memory alloy elements. Alternatively, these elements may be used together with the third magnetic element 1610, the fourth magnetic element 1620, the second magnetic permeable element 1520, and the third magnetic permeable element 1530, depending on design requirement.

In summary, an optical element driving mechanism is provided in some embodiments of the present disclosure, which includes a movable portion, a fixed portion, and a driving assembly. The movable portion is movable relative to the fixed portion. The driving assembly is used for driving the movable portion to move relative to the fixed portion. Therefore, the moving direction of the movable portion relative to the fixed portion may be more stable to achieve a better image-capturing result.

The relative positions and size relationship of the elements in the present disclosure may allow the driving mechanism achieving miniaturization in specific directions or for the entire mechanism. Moreover, different optical modules may be combined with the driving mechanism to further enhance optical quality, such as the quality of photographing or accuracy of depth detection. Therefore, the optical modules may be further utilized to achieve multiple anti-vibration systems, so image stabilization may be significantly improved.

Although embodiments of the present disclosure and their advantages already have been described in detail, it should be understood that various changes, substitutions and alterations may be made herein without departing from the spirit and the scope of the disclosure as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are also intended to include within their scope of such processes, machines, manufacture, and compositions of matter, means, methods, or steps. In addition, each claim herein constitutes a separate embodiment, and the combination of various claims and embodiments are also within the scope of the disclosure.

1. An optical element driving mechanism, comprising:
a movable portion used for connecting an optical element;
a fixed portion, wherein the movable portion is movable relative to the fixed portion; and
a driving assembly used for driving the movable portion to move relative to the fixed portion.

2. The optical element driving mechanism as claimed in claim 1, further comprising:
a first magnetic permeable element disposed on the fixed portion;
a second magnetic permeable element disposed on the fixed portion;
a third magnetic permeable element disposed on the fixed portion;
a third magnetic element disposed on the movable portion;
a fourth magnetic element disposed on the movable portion; and
a guiding assembly disposed on the fixed portion, comprising:
a first guiding element disposed on the fixed portion; and
a second guiding element disposed on the fixed portion.

3. The optical element driving mechanism as claimed in claim 2, wherein the driving assembly comprises:
a first magnetic element disposed on the movable portion;
a second magnetic element disposed on the movable portion;
a first driving coil disposed on the fixed portion and corresponding to the first magnetic element; and
a second driving coil disposed on the fixed portion and corresponding to the second magnetic element.

4. The optical element driving mechanism as claimed in claim 3, wherein:
the first magnetic element corresponds to the first guiding element;
the second magnetic element corresponds to the second guiding element;
the first magnetic element corresponds to the first magnetic permeable element;
the third magnetic element corresponds to the second magnetic permeable element;
the fourth magnetic element corresponds to the third magnetic permeable element.

5. The optical element driving mechanism as claimed in claim 4, wherein:
the first magnetic element and the first guiding element generates a first force to the movable portion;
the second magnetic element and the second guiding element generates a second force to the movable portion;
the first magnetic element and the first magnetic permeable element generates a third force to the movable portion;
the third magnetic element and the second magnetic permeable element generates a fourth force to the movable portion;
the fourth magnetic element and the third magnetic permeable element generates a fifth force to the movable portion.

6. The optical element driving mechanism as claimed in claim 5, wherein:
the first force, the second force, the third force, the fourth force, and the fifth force generates a resultant force to the movable portion;
the resultant force is greater than zero in a first direction;
the resultant force is greater than zero in a second direction;
the first direction and the second direction are perpendicular;
a direction of the first force is not parallel and not perpendicular to the first direction;
the direction of the first force is not parallel and not perpendicular to the second direction;
a direction of the second force is not parallel and not perpendicular to the first direction;
the direction of the second force is not parallel and not perpendicular to the second direction.

7. The optical element driving mechanism as claimed in claim 6, wherein:
a direction of the third force is parallel to the first direction;
a direction of the fourth force is parallel to the second direction;
a direction of the fifth force is parallel to the first direction.

8. The optical element driving mechanism as claimed in claim 7, wherein:
a first distance is between the first magnetic permeable element and the first magnetic element in the first direction;
a second distance is between the second magnetic permeable element and the third magnetic element in the second direction;
a third distance is between the third magnetic permeable element and the fourth magnetic element in the first direction;
the first distance and the second distance are different;
the first distance and the third distance are different;
the second distance and the third distance are different.

9. The optical element driving mechanism as claimed in claim 8, wherein:
the first magnetic element has a first length in the second direction;
the second magnetic element has a second length in the first direction;
the third magnetic element has a third length in the first direction;
the fourth magnetic element has a fourth length in the second direction;
the first length and the third length are different;
the first length and the fourth length are different;
the second length and the third length are different;
the second length and the fourth length are different.

10. The optical element driving mechanism as claimed in claim 9, wherein:
the first distance is greater than the third distance;
the first length is greater than the third length;
the first length is greater than the fourth length.

11-20. (canceled)

21. The optical element driving mechanism as claimed in claim 10, wherein:
the second length is greater than the third length;
the second length is greater than the fourth length.

22. The optical element driving mechanism as claimed in claim 21, wherein:
the fixed portion comprises a bottom;
the first magnetic permeable element is disposed on the bottom;
the second magnetic permeable element is disposed on the bottom;
the third magnetic permeable element is disposed on the bottom;
the bottom comprises a bottom portion positioned between the second magnetic permeable element and the third magnetic permeable element;
the bottom is not disposed between the third magnetic element and the fourth magnetic element.

23. The optical element driving mechanism as claimed in claim 22, wherein:
the fixed portion comprises a first side, a second side, a third side, and a fourth side;
the first side is adjacent to the second side;
the first side is adjacent to the third side;
the second side is adjacent to the fourth side;
the third side is adjacent to the fourth side.

24. The optical element driving mechanism as claimed in claim 23, wherein:
the first driving coil is disposed on the first side;
the second driving coil is disposed on the second side.

25. The optical element driving mechanism as claimed in claim 24, wherein no driving coil is disposed on the third side and the fourth side.

26. The optical element driving mechanism as claimed in claim 25, wherein:
the bottom comprises a first recess and a second recess;
the first guiding element is disposed in the first recess;
the second guiding element is disposed in the second recess;
the first recess comprises a first contact surface and a second contact surface;
the second recess comprises a third contact surface;
the first guiding element is in direct contact with the first contact surface and the second contact surface;
the second guiding element is in direct contact with the third contact surface.

27. The optical element driving mechanism as claimed in claim 26, wherein:
the second recess further comprises a first limiting surface and a second limiting surface;
the third contact surface is adjacent to the first limiting surface and the second limiting surface;
the third contact surface is between the first limiting surface and the second limiting surface;
the second guiding element is not in contact with the first limiting surface and the second limiting surface.

28. The optical element driving mechanism as claimed in claim 27, wherein:
the movable portion comprises an opening;
a main axis passes through a center of the opening;
the main axis extends in a direction perpendicular to the first direction and the second direction;
a first line passes through the first guiding element and the second guiding element when viewed along the main axis;
a second line passes through the center and is perpendicular to the first line when viewed along the main axis;
a third line extends in the first direction and passes through a center of the first magnetic element when viewed along the main axis;
a fourth line extends in the second direction and passes through a center of the third magnetic element when viewed along the main axis;
a fifth line extends in the first direction and passes through a center of the fourth magnetic element when viewed along the main axis;
a direction of the resultant force is a third direction;
the third direction is not perpendicular to a direction that the first line extends;
the third direction is not parallel to a direction that the second line extends;
the first line does not pass through the center;
the third line and the fifth line do not overlap each other;
the third line does not pass through the center;
the fourth line does not pass through the center;
the fifth line does not pass through the center;
the center and the fifth line are positioned on opposite sides of the third line;
normal force between the first guiding element and the first contact surface is different than normal force between the first guiding element and the second contact surface.

29. The optical element driving mechanism as claimed in claim 28, wherein:
an angle between the third direction and the first direction is less than an angle between the third direction and the second direction;
the first guiding element and the third magnetic element are disposed on an identical side of the second line;
the second guiding element and the fourth magnetic element are disposed on an identical side of the second line;
the normal force between the first guiding element and the first contact surface is greater than the normal force between the first guiding element and the second contact surface.

30. The optical element driving mechanism as claimed in claim 19, wherein:
the driving assembly further comprises a position sensing element;
the position sensing element and the first guiding element are disposed on an identical side of the second line when viewed along the main axis;
the optical element driving mechanism further comprises a circuit element and a temperature sensing element;
the position sensing element and the temperature sensing element are disposed on the circuit element;
the temperature sensing element is disposed on a corner of the optical element driving mechanism.
